(19) United States
(12) Patent Application Publication
(10) Pub. No.: US 2018/0309201 A1
(43) Pub. Date: Oct. 25, 2018

(54) SYSTEMS AND METHODS FOR MULTILAYER ANTENNA STRUCTURE

(71) Applicant: SIVOLAM MARKETING LTD., Rishon LeZion (IL)

(72) Inventor: Israel SIBONI, Kibbutz Negba (IL)

(21) Appl. No.: 15/768,726

(22) PCT Filed: Oct. 10, 2016
(86) PCT No.: PCT/IL2016/051098

§ 371 Date: Apr. 16, 2018

Related U.S. Application Data
(60) Provisional application No. 62/241,169, filed on Oct. 14, 2015.

(51) Int. Cl. H01Q 9/04; H01Q 1/40

(52) U.S. Cl. CPC H01Q 9/0414; H01Q 1/48; H01Q 1/40

(57) ABSTRACT

Systems and methods for multilayer antenna structure comprising: a first inner layer comprising at least one printed circuit board wherein most or all of said first inner layer is encapsulated in at least one layer; a second inner layer comprising at least one reflector comprised of metal foil; an external layer encapsulating said first and second inner layers wherein said external layer comprises: at least two polymer boards, each on opposites sides of said first and second inner layers and wherein said polymer boards strengthen by at least one external layer on opposites sides of each said boards, wherein the inner part of said structure is devoid or almost devoid gaps containing air.

This nonprovisional application is a National Stage of International Application No. PCT/IL2016/051098, which was filed on Oct. 10, 2016, and which claims priority to U.S. Application No. 62/241,169, which was filed in US on Oct. 14, 2015, and which are both herein incorporated by reference.

### BACKGROUND

### 1. Technical Field

Embodiments of the present invention relate generally to systems and methods for multilayer antenna structure.

### DESCRIPTION OF RELATED ART

As known in the art, a panel antenna usually has an aluminum ground plane, one or more PCB panels and a radome. The ground plane is a structural part that provides rigidity to the structure as well as serves as a foundation to the entire antenna assembly. The electric function of the ground plane is to serve as a reflector for the electromagnetic (EM) energy radiated from the PCB components, in the opposite direction.

The radome protects the components within against the environment and has to be matched with the rest of the radiation design of the antenna. Radome normally will be sealed to the ground plane in order to keep moisture away from the antenna enclosure.

As the overall structure is sealed, the air trapped inside is subject to expansion and contraction due to ambient temperature changes. The antenna and radome are designed to compensate air pressure changes inside the sealed space.

A panel antenna structure may be described as a flat metal ground plane with a set of poles that hold a PCB with radiating elements. There may be more than one PCB, each distanced from the ground and from each other by a mechanical spacing element in accurate distance. The whole of the radiating enclosure is covered with a radome. The radome and the metal ground plane usually have a rubber seal in between, which is tightened with a set of fasteners along the ground plane periphery.

As the described structures and methods are complex and expensive an improved systems and methods as described in this application are still a long felt need.

### BRIEF SUMMARY

According to an aspect of the present invention a multilayer antenna structure comprising: a first inner layer comprising at least one printed circuit board wherein most or all of said first inner layer is encapsulated in at least one layer; a second inner layer comprising at least one reflector comprised of metal foil; an external layer encapsulating said first and second inner layers wherein said external layer comprises: at least two polymer boards, each on opposites sides of said first and second inner layers and wherein said polymer boards strengthen by at least one external layer on opposites sides of each said boards, wherein the inner part of said structure is devoid or almost devoid gaps containing air.

In another implementation of the invention said first inner layer encapsulating layer comprise only dielectric material.

In another implementation of the invention said first inner layer encapsulating layer comprise only non-lossy material.

In another implementation of the invention said second inner layer comprising polymer board with metal foil on at least one of its sides.

In another implementation of the invention said metal foil is copper foil.

In another implementation of the invention said encapsulating materials are adhesive materials.

In another implementation of the invention said adhesive materials allow binding using heat.

In another implementation of the invention said adhesive materials allow binding using pressure.

In another implementation of the invention said structure most outer layer is UV and environment factors resistant.

It is further within provision of the invention to further comprise a method for fabricating a multilayer antenna structure comprising steps of: providing a first inner layer comprising at least one printed circuit board; encapsulating said first inner layer in part or in whole in at least one layer; providing a second inner layer comprising at least one reflector comprised of metal foil; encapsulating both first and second inner layers in part or in whole within an external layer wherein said external layer comprises: at least two polymer boards, each on opposites sides of said first and second inner layers and wherein said polymer boards strengthen by at least one external layer on opposites sides of each said boards.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates an exploded view of the components of an embodiment of the present invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for multilayer antenna structure.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The invention relates to systems and methods for multilayer antenna structure that may simplify the general structure and lower the costs of such panel antennas (for example, flat, printed circuit board, microstrip, etc.), particularly when more than one PCB panel and a solid structural metal ground plane are utilized.

Very generally speaking, the system and method may allow replacing the air gaps within an antenna with polymer boards with heat or pressure sensitive adhesive external layers/coats wherein all the layers will be fused to each other leaving no air in between. The ground plane may be replaced with a metal foil which in turn is fused as well to the bottom of the antenna sandwich. The radome may be replaced with a thin polymer board sufficient to withstand the environmental factors and will be fused as well to the top printed circuit board (hereinafter: “PCB”) in the structure. The overall sandwich structure provides enough rigidity to withstand the wind load required by various applications and will not delaminate. The invention may eliminate the traditional solid metal ground plane with metal and polymer stand offs, traditional molded radome, seal and fasteners etc.

As can be appreciated, the invention provides an antenna structure in which the mechanical parts may be replaced, in part or in whole, with layers of polymer and metal foil which may be fused to one another to create a single unit causing significant reduction of weight and dimension as well as cost of manufacturing, packaging and transporting costs.

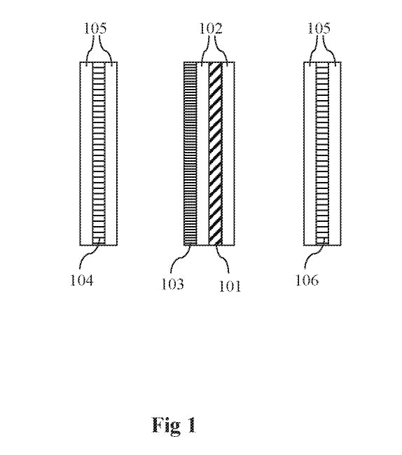

FIG. 1. depicts an embodiment of the present invention in which the multilayer antenna structure comprises a first inner layer 101 comprising one or more printed circuit board, as known in the art, such printed boards may comprise all the active elements required for an antenna such radiating elements, transmission lines, coupled slots, etc., on its different layers.

The printed boards may be encapsulated in whole or part in at least one layer

The encapsulation may cover the entire first inner layer or cover parts of it. In an embodiment of the invention, the encapsulation of the first inner layer may be done only in part, i.e. only covering the active or conductive parts of the board. In other embodiments of the invention, the encapsulation is complete.

In some embodiments of the invention, the encapsulation is achieved using only dielectric material or non-lossy material. As known in the art, insulators become lossy and hence become resistors are a major problem in antennas, i.e. the PCB substrate and the polymer boards apply lowest dielectric loss polymer materials as it is known the most of the energy loss in the transmission lines goes into the polymer.

As further depicted in FIG. 1 the structure comprises a second inner layer comprising at least one reflector comprised of metal foil 103. In some embodiments of the invention the metal foil is a copper foil. In some embodiments of the invention, the metal foil may be pre-coated with a polymer layer to secure fusing. In further embodiments of the invention, the second inner layer may comprise polymer board with metal foil on at least one of its sides. In some embodiments of the invention, the metal foil may be replaced with any metal or even any other conductive material such as conductive polymers.

The inner layers may further be encapsulated by an external layer. Such external layer in intended to replace the commonly used radome. As known in the art, the radome is a structural, weatherproof enclosure that protects an antenna and is constructed of material that minimally attenuates and may reflect the electromagnetic signal transmitted or received by the antenna. Radomes protect antenna surfaces from weather and/or conceal antenna electronic equipment from public view. In an embodiment of the present invention, the external layer may act as a radome and may comprise at least two polymer boards 104, each on opposite's sides of the inner layers. The polymer boards may strengthen by at least one external layer on opposites sides of each board 105, for example by using carton boards or any other material.

In some embodiments of the invention, one of the two polymer boards 106 may be comprised of a printed board in whole or in part.

In some embodiments of the invention, the entire inner part will devoid or almost devoid any gaps filled with air. Adhesive materials bonding the layers will replace any air bubble or gap, hence creating a solid one-piece rigid antenna comprising both the structural elements and the active elements in a single piece that may be environment resistant and energy conserving.

In further embodiments of the invention, all or some of the encapsulating materials may be made in part or in whole of adhesive materials. In some embodiments of the invention said adhesive materials may allow binding using heat and/or pressure. In other embodiments of the invention, other kinds of adhesive may be used.

In some embodiments of the invention, the multilayer antenna structure most outer layer may be UV and/or other environment factors resistant (such as wind, moisture, ice, heat, cold, etc.). In further embodiments, this most outer layer may be a foamed polymer which thickness may be 0.5 to 100 mm to distance possible snow and ice deposits away from the conductive radiating layer.

In some embodiments of the invention, the commonly used ground plane may be replaced with a metal foil fused to the bottom of the antenna sandwich.

In some embodiments of the invention, the polymer boards may be foamed to various foaming levels in order to determine or reduce insertion loss and dielectric constant as well as in order to determine or reduce weight and costs.

In some embodiments of the invention, a preferred dissipation factor of all the spacer layers and the radome may be similar to that of the printed board circuit substrate.

In some embodiments of the invention, polymer boards may be used as spacers. In other embodiments of the invention, polymer or metal fasteners may be run through the system while not interfering with conductive and radiating elements in order to fix pole brackets (orientation device).

In further embodiments of the invention, the polymer boards may be enhanced and more rigid using additional polymer or metal rigidity enhancing structures, i.e. in cases in which the high surface span of the antenna assembly is problematic and the overall rigidity may not be sufficient to face a required wind load. Increasing the survival (sustainability) capacity may be achieved by attaching rigidity enhancing elements.

In some embodiments of the invention, a ground may be used as one of a PCB sides which may be left untouched or almost untouched, while the other PCB side may form a complex radiating element array. This may be used for narrow bandwidth specialty antennas. Such designs, if not encapsulated in a sealed radio (like a laptop PC, mobile terminal, etc.), may still require an environment seal on the etched PCB side and oxidation protective coat or layer on the reflector (ground) side.

In some embodiments of the invention, a method for fabricating a multilayer antenna structure comprising steps of:

providing a first inner layer comprising at least one printed circuit board;
encapsulating said first inner layer in part or in whole in at least one layer;
providing a second inner layer comprising at least one reflector comprised of metal foil;
encapsulating both first and second inner layers in part or in whole within an external layer wherein said external layer comprises: at least two polymer boards, each on opposites sides of said first and second inner layers and wherein said polymer boards strengthen by at least one external layer on opposites sides of each said boards.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1-21. (canceled)

22. A radome-less weather resistant multilayer antenna structure comprising:
a first inner layer comprising at least one printed circuit board wherein most or all of said first inner layer is encapsulated in at least one layer;
a second inner layer comprising at least one reflector comprised of conductive material; and
an external layer encapsulating said first and second inner layers wherein said external layer comprises: at least two polymer boards, each on opposites sides of said first and second inner layers and wherein each of said polymer boards strengthen by at least one external layer on opposites sides of each of said boards,
wherein said encapsulation comprise heat sensitive adhesive,
wherein said adhesive materials allow binding using heat,
wherein said structure is devoid gaps containing air, and
wherein all of said layers creates a solid single piece rigid antenna structure.

23. The multilayer antenna structure of claim 22 wherein said conductive material is selected from the group comprising: metal foil, metal sheet, conductive paint and conductive polymers.

24. The multilayer antenna structure of claim 22 wherein said first inner layer encapsulating layer comprise only dielectric material.

25. The multilayer antenna structure of claim 22 wherein said first inner layer encapsulating layer comprise only non-lossy material.

26. The multilayer antenna structure of claim 22 wherein said second inner layer comprising polymer board with metal foil on at least one of its sides.

27. The multilayer antenna structure of claim 25 wherein said adhesive materials allow binding using pressure.

28. The multilayer antenna structure of claim 22 wherein said structure most outer layer is UV and environment factors resistant.

29. The multilayer antenna structure of claim 22 wherein at least one of said external layer boards is a printed circuit board.

30. A method for fabricating a radome-less weather resistant multilayer solid single piece rigid antenna structure comprising:
providing a first inner layer comprising at least one printed circuit board;
encapsulating said first inner layer in part or in whole in at least one layer;
providing a second inner layer comprising at least one reflector comprised of metal foil; and
encapsulating both first and second inner layers in part or in whole within an external layer,
wherein said external layer comprises at least two polymer boards, each on opposites sides of said first and second inner layers, and
wherein each of said polymer boards strengthen by at least one external layer on opposites sides of each of said boards, and
wherein said encapsulation comprise heat sensitive adhesive wherein said adhesive materials allow binding using heat.

31. The method of claim 30 wherein said first inner layer encapsulating layer comprise only dielectric material.

32. The method of claim 30 wherein said first inner layer encapsulating layer comprise only non-lossy material.

33. The method of claim 30 wherein said second inner layer comprising polymer board with metal foil on at least one of its sides.

34. The method of claim 30 wherein said adhesive materials allow binding using pressure.

35. The method of claim 30 wherein said structure most outer layer is UV and environment factors resistant.

36. The method of claim 30 wherein at least one of said external layer boards is a printed circuit board.

37. The multilayer antenna structure of claim 22 wherein said conductive radiating pattern has at least one two-dimensional radiating element.

38. The multilayer antenna structure of claim 22 wherein said first inner layer comprises at least four printed circuit boards.

39. The method of claim 30 wherein said first inner layer comprises at least four printed circuit boards.

40. The multilayer antenna structure of claim 22 wherein said structure is at least 2 square foot.

41. The method of claim 30 wherein said structure is at least 2 square foot.
